(19) United States
(12) Patent Application Publication
(10) Pub. No.: US 2015/0294385 A1
(43) Pub. Date: Oct. 15, 2015

(54) DISPLAY OF THE BUDGET IMPACT OF ITEMS VIEWABLE WITHIN AN AUGMENTED REALITY DISPLAY

(71) Applicant: Bank of America Corporation, Charlotte, NC (US)

(72) Inventors: David M. Grigg, Rock Hill, SC (US); Richard Andrew Starbuck, Walnut Creek, CA (US)

(73) Assignee: Bank of America Corporation, Charlotte, NC (US)

(21) Appl. No.: 14/249,698

(22) Filed: Apr. 10, 2014

(51) Int. Cl. G06Q 30/06

(52) U.S. Cl. CPC G06Q 30/0613

(57) ABSTRACT

Systems, apparatus, and computer program items are provided for presenting budget information in connection with items within a live video stream of an augmented reality display on a mobile communication device. The invention allows the user who customarily comes in to contact with items throughout the day to able to gauge the budget impact of the purchase of such items and/or immediately ascertain whether certain items being considered for purchase are within the limits of a user's budget or a budget category. By automatically providing such information to the user in a highly efficient manner, the user can make informed decisions on whether a purchase is advisable and/or which purchase options are most suitable to the user's budget.

### FIELD

In general, embodiments herein disclosed relate to personal finance management and, more specifically, determining budget information, such budget impact information, associated with items displayed within a live video stream on a mobile communication device and presenting an augmented reality display of the budget information within the live video stream displayed on the mobile communication device.

### BACKGROUND

Modern mobile communication devices, such as smart phones, wearable computers having Optical Head-Mounted Displays (OHMD) or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have addition features that are becoming increasing more common and standardized features. Such features include, but are not limited to, location-determining devices, such as Global Positioning System (GPS) devices; sensor devices, such as accelerometers; and high-resolution video cameras.

Therefore, a need exists to further the capabilities of mobile communication devices and, in particular leverage augmented-reality type analysis to provide mobile communication device user's with greater access to information.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program items are described herein that provide for presenting budgetary information, such as budget impact or the like, in conjunction with a live video stream captured by a mobile communication device that includes the item or a description of the item that a user may considering purchasing. Purchase prices of the item may be identified from the live video stream by reading text in the video stream or an image-based code (e.g., barcode, Quick Response (QR) code or the like) captured in the video stream. Alternatively, items in the live video stream may be identified, and subsequently purchase price determined, by implementation of object recognition techniques. Once the purchase price of items within the live video stream have been identified, budgetary information, such as the impact on a budget or budget category, whether an item meets current budget or budget category limits or the like is determined by comparing the purchase price to a financial budget associated with the user of the mobile communication device. In response to determining the budgetary information, budget information indicators are presented within the live video stream display of the mobile communication device. Each budget information indicator is associated with the determined budget information and is attached to a corresponding item so as to follow the corresponding item as the corresponding item moves within the live video stream displayed on the mobile communication device, thereby creating an augmented reality display of the items within the live video stream.

An apparatus for presenting budget-information in conjunction with a live video stream display of one or more items on a mobile communication device, defines first embodiments of the invention. The apparatus includes a mobile communication device (e.g., smart phone, wearable computer including an OHMD or the like) including a computing platform having a processor, a memory in communication with the processor and an image capturing device in communication with the processor.

The apparatus further includes a purchase price identification application stored in the memory, executable by the processor and the image capturing device and configured to capture a live video stream of a surrounding environment that includes one or more items and determine that one or more images in the live video stream identify a purchase price of the one or more items. In specific embodiments of the apparatus, the purchase price identification application is identify the purchase price of the one or more items by reading indicia and/or an image-based code captured by the mobile communication device. Additionally, the indicia or image-based code may further identify the one or more items. In other embodiments the apparatus includes an item identification application stored in the memory, executable by the processor and the image capturing device and configured to determine that one or more images in the live video stream identify the one or more items or a category for the one or more items. In such embodiments of the apparatus, the item identification application may be configured to implement object recognition processing that provides for identifying the items in the live video stream based on pattern recognition that compares images of the items to stored markers associated with the items. In such embodiments of the apparatus, the purchase price identification application may further be configured to identify the purchase price of identified items by accessing a pricing database that stores purchase prices for listed items.

The apparatus further includes a budget information determination application stored in the memory, executable by the processor and configured to determine budgetary information based on the purchase price of the items and a financial budget associated with a user of the mobile communication device. In specific embodiments of the apparatus, the budget information determination application is configured to compare the purchase price of an item to the financial budget associated with the user to determine an impact on the financial budget based on the user purchasing the item. In other embodiments of the apparatus, the budget information determination application is configured to compare the purchase price of an item to the financial budget associated with the user to determine items within the view that are within the user's current budget limits/constraints. In still further specific embodiments of the apparatus, the budget information application is configured to determine a budget category for each of the identified items, compare the purchase price to the determined budget category within the financial budget to determine an impact on the budget category based on the user purchasing the item.

The apparatus further includes a budget information presentation application stored in the memory, executable by the processor and configured to, in response to determining the budgetary information, present, within the live video stream displayed on the mobile communication device, one or more budget information indicators. Each budget information indicator is associated with the determined budget information and is attached to a corresponding item so as to follow the corresponding item as the corresponding item moves within the live video stream displayed on the mobile communication device. The budget information indicator may highlight, superimpose, or outline the item to which the indicator is attached. In this regard, the budget information indicator creates an augmented reality display of the budget information. In specific embodiments of the apparatus, the budget information indicators may be configured to indicate the impact on the financial budget and/or a category within the budget of the user purchasing the item or the budget information indicators may correspond to items that are within budgetary limits of the user.

A method for presenting budget-information in conjunction with a live video stream display of one or more items on a mobile communication device, defines second embodiments of the invention. The method includes capturing a live video stream of a surrounding environment that includes one or more items and determining a purchase price of one or more of the items based on one or more images in the captured live video stream. The method further includes, in response to determining the purchase price of the items, determining budgetary information based on the purchase price of the items and a financial budget associated with a user of the mobile communication device. In addition, the method includes in response to determining the budgetary information, presenting, within the live video stream displayed on the mobile communication device, one or more budget information indicators. Each budget information indicator is associated with the determined budget information and is attached to a corresponding item so as to follow the corresponding item as the corresponding item moves within the live video stream displayed on the mobile communication device.

In specific embodiments the method additionally includes determining that one or more images in the live video stream identify, at least one of (1) the one or more items or (2) a category for the one or more items. In such embodiments of the method, determining that one or more images in the live video stream identify the items may further include implementing object recognition processing that provides for identifying the items in the live video stream based on pattern recognition that compares images of the items to stored markers associated with the items. In such embodiments of the invention, determining the purchase price of the one or more items may further include determining the purchase price of identified items by accessing a pricing database that provides purchase prices for items listed in the database.

In other specific embodiments of the method, determining the purchase price of items further includes reading indicia and/or an image-based code captured by the mobile communication device in the live video stream. In such embodiments, the indicia or code may further be read to identify the items.

In other specific embodiments of the method, determining budgetary information further includes comparing the purchase price of an item to the financial budget associated with the user to determine an impact on the financial budget based on the user purchasing the item, In such embodiments of the method, presenting one or more budget indicators further includes presenting, within the live video stream displayed on the mobile communication device, the one or more budget information indicators that indicate the impact on the financial budget of the user purchasing the item.

In other specific embodiments of the method, determining budgetary information further includes comparing the purchase price of an item to the financial budget associated with the user to determine that the item is within budgetary limits of the financial budget of the user. In such embodiments of the method, presenting one or more budget indicators further includes presenting, within the live video stream displayed on the mobile communication device, the one or more budget information indicators that correspond to items that are within budgetary limits of the user.

In still further embodiments the method includes determining a budget category for each of the identified items and comparing the purchase price of one of the items to the determined budget category within the financial budget to determine an impact on the budget category based on the user purchasing the item. In such embodiments of the method, presenting the budget information indicators further includes, in response to determining the impact on the budget category, presenting, within the live video stream displayed on the mobile communication device, the one or more budget information indicators that indicate the impact on the budget category of the user purchasing the item.

A computer program product including a non-transitory computer-readable medium defines third embodiments of the invention. The computer-readable medium includes a first set of codes for causing a computer to capture a live video stream of a surrounding environment that includes one or more items. In addition, the computer-readable medium includes a second set of codes for causing a computer to determine a purchase price of one or more of the items based on one or more images in the captured live video stream. Additionally, the computer-readable medium includes a third set of codes for causing a computer to, in response to determining the purchase price of the items, determine budgetary information based on the purchase price of the items and a financial budget associated with a user of the mobile communication device. Moreover, the computer-readable medium includes a fourth set of codes for causing a computer to, in response to determining the budgetary information, present, within the live video stream displayed on the mobile communication device, one or more budget information indicators, each budget information indicator associated with the determined budget information and attached to a corresponding item so as to follow the corresponding item as the corresponding item moves within the live video stream displayed on the mobile communication device.

Thus, embodiments of the present invention provide a unique means for presenting budget information to a user. Specifically, the present invention allows the user who customarily comes in to contact with items throughout the day to able to gauge the budget impact of the purchase of such items and/or immediately ascertain whether certain items being considered for purchase are within the limits of a user's budget or a budget category (e.g., food, clothes, entertainment categories or the like). By automatically providing such information to the user in a highly efficient manner, the user can make informed decisions on whether a purchase is advisable and/or which purchase options are most suitable to the user's budget.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile communication device, in accordance with an embodiment of the invention;

FIG. 2 is a block diagram illustrating an object recognition environment, in accordance with an embodiment of the invention;

FIG. 3 is a block diagram illustrating a mobile communication device, in accordance with an embodiment of the invention;

FIG. 4 is a block diagram of an apparatus configured to present product offers in conjunction with display of the product in a live video stream on a mobile communication device, in accordance with embodiment of the present invention;

FIG. 5 is an additional block diagram of an apparatus configured to present product offers, warranty offers and new product offers/information in conjunction with display of the product in a live video stream on a mobile communication device, in accordance with embodiment of the present invention; and

FIG. 6 is a flow diagram illustrating a method for presenting product offers in conjunction with display of the product in a live video stream on a mobile communication device, in accordance with embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, applications, and the like. It is to be understood and appreciated that the various systems may include additional devices, components, applications, etc. and/or may not include all of the devices, components, applications etc. discussed in connection with the figures. A combination of these approaches may also be used.

The steps and/or actions of a method or algorithm described in connection with the embodiments disclosed herein may be embodied directly in hardware, in a software application executed by a processor, or in a combination of the two. A software application may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for presenting budgetary information on mobile communication devices and, specifically presenting budgetary information in conjunction the display of items within a live video stream. Specific embodiments of the invention rely on presenting budgetary information in an Augmented Reality (AR) environment, or more generally referred to as mediated reality, in which the budgetary information is shown as being associated with an object (i.e., an object associated with the item of interest) in the live video stream. The mobile communication device may be any device capable of network communication and equipped with an image/video capturing device and a display, for example, a smart telephone or a wearable computer, such as a wearable computer incorporating an Optical Head-Mounted Display (OHMD) or the like.

One such example of an AR application platform is Layar, available from Layar, Amsterdam, the Netherlands. The Layar platform technology analyzes location data, compass direction data, and the like in combination with information related to the objects, locations or the like in the video stream to create browse-able “hot-spots” or “tags” that are superimposed on the mobile communication device display with respect to a corresponding object displayed on the mobile communication device, resulting in an experience described as “reality browsing”.

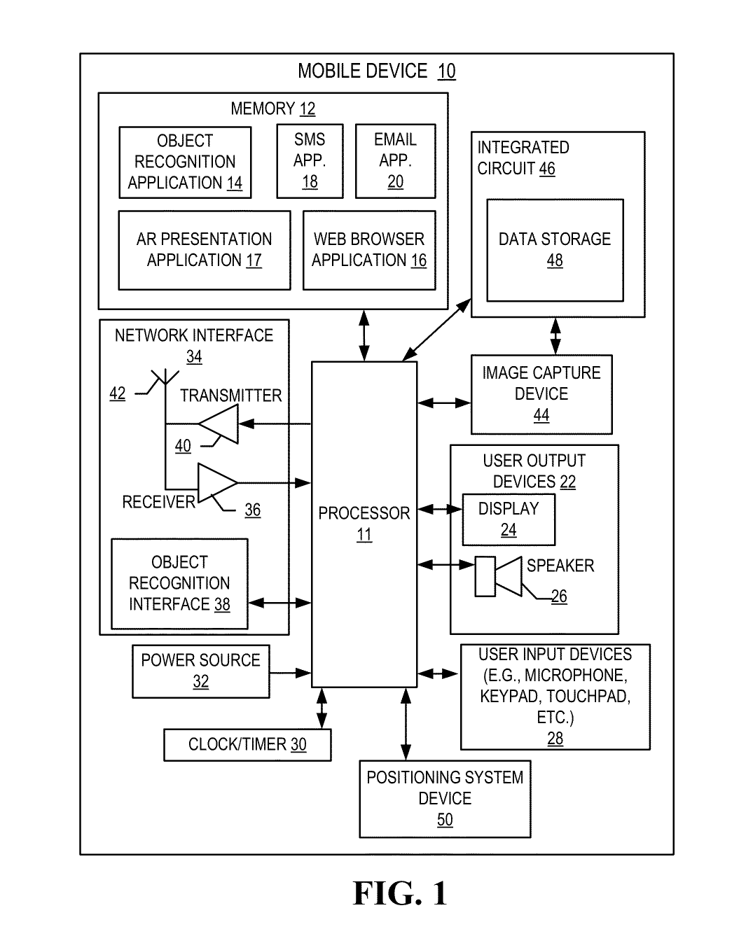

FIG. 1 illustrates an embodiment of a mobile communication device 10 that may be configured to execute object recognition and Augmented Reality (AR) functionality, in accordance with specific embodiments of the present invention. A “mobile communication device” 10 may be any mobile communication device, such as a cellular telecommunications device (i.e., a cell phone or mobile phone), personal digital assistant (PDA), a mobile Internet accessing device, a wearable computing device including an OHMD or any other mobile communication device including, but not limited to portable digital assistants (PDAs), pagers, mobile televisions, gaming devices, laptop computers, cameras, video recorders, audio/video player, radio, GPS devices, any combination of the aforementioned, or the like.

It should be noted that while the mobile communication device 10 of FIG. 1 implements both object recognition technology and AR functionality, object recognition technology is not required in all embodiments of the invention since purchase price and or item identification can be determined by other means, such as capturing image based codes (e.g., barcodes, QR codes or the like) or other indicia that may identify the purchase price and/or product.

The mobile communication device 10 may generally include a processor 11 communicably coupled to such devices as a memory 12, user output devices 22, user input devices 28, a network interface 34, a power source 32, a clock or other timer 30, an image capture device 44, a positioning system device 50 (e.g., a Global Positioning System (GPS) device), one or more integrated circuits 46, etc.

In some embodiments, the mobile communication device and/or the server access one or more databases or data stores (not shown in FIG. 1) to search for and/or retrieve information related to the object and/or marker. In some embodiments, the mobile communication device and/or the server access one or more data stores local to the mobile communication device and/or server and in other embodiments, the mobile communication device and/or server access data stores remote to the mobile communication device and/or server. In some embodiments, the mobile communication device and/or server access both a memory and/or data store local to the mobile communication device and/or server as well as a data store remote from the mobile communication device and/or server.

The processor 11, and other processors described herein, may generally include circuitry for implementing communication and/or logic functions of the mobile communication device 10. For example, the processor 11 may include a digital signal processor device, a microprocessor device, and various analog to digital converters, digital to analog converters, and/or other support circuits. Control and signal processing functions of the mobile communication device 10 may be allocated between these devices according to their respective capabilities. The processor 11 thus may also include the functionality to encode and interleave messages and data prior to modulation and transmission. The processor 11 may additionally include an internal data modem. Further, the processor 11 may include functionality to operate one or more software programs or applications, which may be stored in the memory 12. For example, the processor 11 may be capable of operating a connectivity program, such as a web browser application 16. The web browser application 16 may then allow the mobile communication device 10 to transmit and receive web content, such as, for example, location-based content and/or other web page content, according to a Wireless Application Protocol (WAP), Hypertext Transfer Protocol (HTTP), and/or the like.

The processor 11 may also be capable of operating applications, such as an object recognition application 14. The object recognition application 14 may be downloaded from a server and stored in the memory 12 of the mobile communication device 10. Alternatively, the object recognition application 14 may be pre-installed and stored in a memory in the integrated circuit 46. In such an embodiment, the user may not need to download the object recognition application 14 from a server or otherwise obtain the application 14. In some embodiments, the processor 11 may also be capable of operating one or more applications, such as one or more applications functioning as an artificial intelligence (“AI”) engine. The processor 11 may recognize objects that it has identified in prior uses by way of the AI engine. In this way, the processor 11 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other applications or applications described herein to perform the various steps of the methods discussed. For example, in some embodiments, the AI engine recognizes an object that has been recognized before and stored by the AI engine. The AI engine may then communicate to another application or application of the mobile communication device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

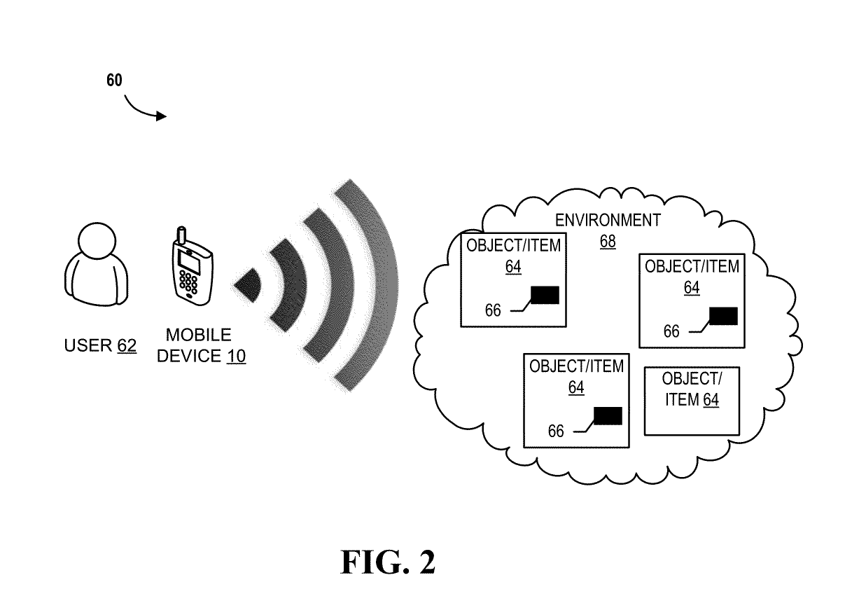

The integrated circuit 46 may include the necessary circuitry to provide the object recognition functionality to the mobile communication device 10. Generally, the integrated circuit 46 will include data storage 48 which may include data associated with the objects within a video stream that the object recognition application 14 identifies as having a certain marker(s) (discussed in relation to FIG. 2). The integrated circuit 46 and/or data storage 48 may be an integrated circuit, a microprocessor, a system-on-a-integrated circuit, a microcontroller, or the like. As discussed above, in one embodiment, the integrated circuit 46 may provide the functionality to the mobile communication device 10.

Of note, while FIG. 1 illustrates the integrated circuit 46 as a separate and distinct element within the mobile communication device 10, it will be apparent to those skilled in the art that the object recognition functionality of integrated circuit 46 may be incorporated within other elements in the mobile communication device 10. For instance, the functionality of the integrated circuit 46 may be incorporated within the mobile communication device memory 12 and/or processor 11. In a particular embodiment, the functionality of the integrated circuit 46 is incorporated in an element within the mobile communication device 10 that provides object recognition capabilities to the mobile communication device 10. Still further, the integrated circuit 46 functionality may be included in a removable storage device such as an SD card or the like.

The processor 11 may be configured to use the network interface 34 to communicate with one or more other devices on a network. In this regard, the network interface 34 may include an antenna 42 operatively coupled to a transmitter 40 and a receiver 36 (together a “transceiver”). The processor 11 may be configured to provide signals to and receive signals from the transmitter 40 and receiver 36, respectively. The signals may include signaling information in accordance with the air interface standard of the applicable cellular system of the wireless telephone network that may be part of the network. In this regard, the mobile communication device 10 may be configured to operate with one or more air interface standards, communication protocols, modulation types, and access types. By way of illustration, the mobile communication device 10 may be configured to operate in accordance with any of a number of first, second, third, and/or fourth-generation communication protocols and/or the like. For example, the mobile communication device 10 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile communication device 10 may also be configured to operate in accordance with non-cellular communication mechanisms, such as via a wireless local area network (WLAN) or other communication/data networks.

The network interface 34 may also include an object recognition interface 38 in order to allow a user to execute some or all of the above-described processes with respect to the object recognition application 14 and/or the integrated circuit 46. The object recognition interface 38 may have access to the hardware, e.g., the transceiver, and software previously described with respect to the network interface 34. Furthermore, the object recognition interface 38 may have the ability to connect to and communicate with an external data storage on a separate system within the network as a means of recognizing the object(s) in the live video stream captured by the mobile communication device 10.

As described above, the mobile communication device 10 may have a user interface that includes user output devices 22 and/or user input devices 28. The user output devices 22 may include a display 24 (e.g., a liquid crystal display (LCD) or the like) and a speaker 26 or other audio device, which are operatively coupled to the processor 11. The user input devices 28, which may allow the mobile communication device 10 to receive data from a user, may include any of a number of devices allowing the mobile communication device 10 to receive data from a user, such as a keypad, keyboard, touch-screen, touchpad, microphone, mouse, joystick, other pointer device, button, soft key, and/or other input device(s).

The mobile communication device 10 may further include a power source 32. Generally, the power source 32 is a device that supplies electrical energy to an electrical load. In one embodiment, power source 32 may convert a form of energy such as solar energy, chemical energy, mechanical energy, etc. to electrical energy. Generally, the power source 32 in a mobile communication device 10 may be a battery, such as a lithium battery, a nickel-metal hydride battery, or the like, that is used for powering various circuits, e.g., the transceiver circuit, and other devices that are used to operate the mobile communication device 10. Alternatively, the power source 32 may be a power adapter that can connect a power supply from a power outlet to the mobile communication device 10. In such embodiments, a power adapter may be classified as a power source “in” the mobile communication device.

The mobile communication device 10 may also include a memory 12 operatively coupled to the processor 11. As used herein, memory may include any computer-readable medium configured to store data, code, or other information. The memory 12 may include volatile memory, such as volatile Random Access Memory (RAM) including a cache area for the temporary storage of data. The memory 12 may also include non-volatile memory, which can be embedded and/or may be removable. The non-volatile memory may additionally or alternatively include an electrically erasable programmable read-only memory (EEPROM), flash memory or the like.

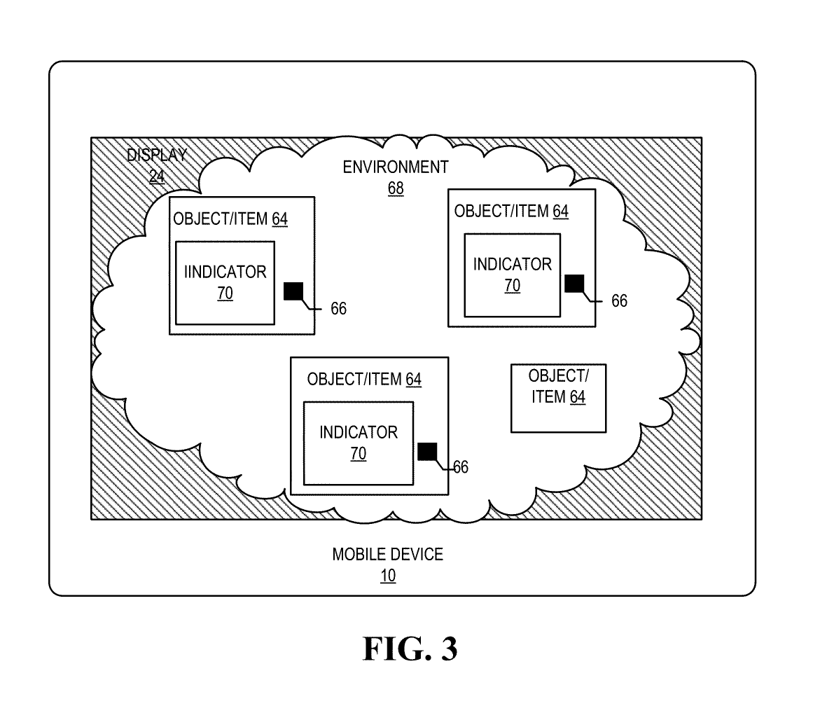

The memory 12 may store any of a number of applications or programs which comprise computer-executable instructions/code executed by the processor 11 to implement the functions of the mobile communication device 10 described herein. For example, the memory 12 may include such applications as an object recognition application 14, an augmented reality (AR) presentation application 17 (described infra. in relation to FIG. 3), a web browser application 16, a Short Message Service (SMS) application 18, an electronic mail (i.e., email) application 20, etc.

Referring to FIG. 2, a block diagram illustrating an object recognition experience 60 in which a user 62 utilizes a mobile communication device 10 to capture a live video stream that includes an environment 68 is shown. As denoted earlier, the mobile communication device 10 may be any mobile communication device, such as a smart phone, a wearable device or the like. The mobile communication device 10 has the capability of capturing a video stream of the surrounding environment 68. The video capture may be by any means known in the art. In one particular embodiment, the mobile communication device 10 is a mobile telephone equipped with an image capture device 44 capable of video capture.

The environment 68 contains a number of objects 64. Some of such objects 64 may include a marker 66 identifiable to an object recognition application that is either executed on the mobile communication device 10 or within the wireless network. A marker 66 may be any type of marker that is a distinguishing feature that can be interpreted by the object recognition application to identify specific objects 64. For instance, a marker 66 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, or the like. In some embodiments, the marker 66 may be audio and the mobile communication device 10 may be capable of utilizing audio recognition to identify words or unique sounds broadcast. The marker 66 may be any size, shape, or the like. Indeed, in some embodiments, the marker 66 may be very small relative to the object 64 such as the alpha-numeric characters that identify the name or model of an object 64, whereas, in other embodiments, the marker 66 is the entire object 64 such as the unique shape, size, structure, or the like.

In some embodiments, the marker 66 is not actually a physical marker located on or being broadcast by the object. For instance, the marker 66 may be some type of identifiable feature that is an indication that the object 64 is nearby (e.g., a tag or placard near the object). In some embodiments, the marker 66 for an object 64 may actually be the marker 66 for a different object 64. For example, the mobile communication device 10 may recognize a particular building as being “Building A.” Data stored in the object recognition data storage may indicate that “Building B” is located directly to the east and next to “Building A.” Thus, markers 66 for an object 64 that are not located on or being broadcast by the object 64 are generally based on fixed facts about the object 64 (e.g., “Building B” is next to “Building A”). However, it is not a requirement that such a marker 66 be such a fixed fact. The marker 66 may be anything that enables the mobile communication device 10 to interpret to a desired confidence level what the object is.

The marker 66 may also be or include social network data, such as data retrieved or communicated from the Internet, such as tweets, blog posts, Facebook posts, various types of messages and/or the like. In other embodiments, the marker 66 is provided in addition to social network data as mentioned above. For example, the mobile communication device 10 may capture a video stream and/or one or more still shots including a large gathering of people. In an example, a person dressed in a specific character costume and multiple people dressed as related specific costumes are present. The mobile communication device 10 may identify several social network indicators, such as posts, blogs, tweets, messages, and/or the like indicating the presence of the specific character at the mall. In this way, the mobile communication device 10 may communicate information regarding the social media communications to the user and/or use the information regarding the social media communications in conjunction with other methods of object recognition. For example, the mobile communication device and/or server performing recognition of the specific character at the mall may confirm that the object being identified is the specific character based on retrieved social media communications.

In some embodiments, the mobile communication device and/or server access one or more other servers, social media networks, applications and/or the like in order to retrieve and/or search for information useful in performing an object recognition. In some embodiments, the mobile communication device and/or server accesses another application by way of an application programming interface or API. In this regard, the mobile communication device and/or server may quickly search and/or retrieve information from the other program without requiring additional authentication steps or other gateway steps.

While FIG. 2 illustrates that the objects 64 with markers 66 only include a single marker 66, it will be appreciated that the object 64 may have any number of markers 66 with each equally capable of identifying the object 66. Similarly, multiple markers 64 may be identified by the mobile communication device 100 such that the combination of the markers 66 may be utilized to identify the object 64. For example, the mobile communication device 10 may utilize facial recognition markers 66 to identify a person as either Person A or Person B and utilize a separate marker 66 such as another identifying characteristic of Person A to confirm the identification to the desired confidence level that the person is Person A.

In some embodiments, a marker 66 may be the location of the object 64. In such embodiments, the mobile communication device 10 may utilize Global Positioning System (GPS) hardware and/or software or some other location determining mechanism to determine the location of the user 62 and/or object 64. As noted above, a location-based marker 66 could be utilized in conjunction with other non-location-based markers 66 identifiable and recognized by the mobile communication device 10 to identify the object 64. However, in some embodiments, a location-based marker may be the only marker 66. For instance, in such embodiments, the mobile communication device 10 may utilize GPS software to determine the location of the user 62 and a compass device or software to determine what direction the mobile communication device 10 is facing in order to identify the object 64. In still further embodiments, the mobile communication device 10 does not utilize any GPS data in the identification. In such embodiments, markers 66 utilized to identify the object 64 are not location-based.

FIG. 3 illustrates a mobile communication device 10, specifically the display 24 of the mobile 10, wherein the device 10 has executed an object recognition application 14 and an AR presentation application 17 to present within the display 24 indications of recognized objects within the live video stream (i.e., surrounding environment 68). The mobile communication device 10 is configured to rely on markers 66 to identify objects 64 that are associated with items, and indicate to the user 62 budgetary information associated with the identified objects 64 by displaying an indicator 70 on the mobile communication device display 130 in conjunction with display of the live video stream. As illustrated, if an object 64 does not have any markers 66 (or at least enough markers 66 to yield object identification), the object 64 will be displayed without an associated indicator 70.

The object recognition application 14 may use any type of means in order to identify desired objects 64. For instance, the object recognition application 14 may utilize one or more pattern recognition algorithms to analyze objects in the environment 68 and compare with markers 66 in data storage 48 which may be contained within the mobile communication device 10 (such as within integrated circuit 46) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 64 within the real-time video stream as item, and/or determining the purchase price of item and determining budget information associated with the item, the AR presentation application 17 is configured to present an indicator 70 on the mobile communication device display 24. The indicator 70 is generally a graphical representation that superimposes, highlights or outlines the item (i.e., object 64) and may be activatable (i.e., include an embedded link), such that the user 62 may “select” the indicator 70 and retrieve budgetary information related to the identified object. The budgetary information may include any desired information associated with the selected object and may range from basic information to greatly detailed information. In some embodiments, the indicator 70 may provide the user 62 with an internet hyperlink to further budgetary-related information on the object 64. The information may include, for example, all types of media, such as text, images, clipart, video clips, movies, or any other type of information desired. In yet other embodiments, the indicator 70 information related to the identified object may be visualized by the user 62 without “selecting” the indicator 70.

In embodiments in which the indicator 70 provides an interactive tab to the user 62, the user 62 may select the indicator 70 by any conventional means, e.g., keystroke, touch, voice command or the like, for interaction with the mobile communication device 10. For instance, in some embodiments, the user 62 may utilize an input device 28 such as a keyboard/keypad to highlight and select the indicator 70 in order to retrieve the budget-related information. In a particular embodiment, the mobile communication device display 24 includes a touch screen that the user may employ to select the indicator 70 utilizing the user's finger, a stylus, or the like.

In some embodiments, the indicator 70 is not be interactive and simply provides budget-related information to the user 62 by superimposing the indicator 70 onto the display 24. For example, in some instances it may be beneficial for the AR presentation application 17 to merely identify an object 64, e.g., identify the item's name/title, give brief information about the item, such as the purchase price, state whether the item is within budget limits etc., rather than provide extensive detail that requires interaction with the indicator 70. The AR presentation application 17 is capable of being tailored to a user's desired preferences.

Furthermore, the indicator 70 may be displayed at any size on the mobile communication device display 24. The indicator 70 may be small enough that it is positioned on or next to the object 64 being identified such that the object 64 remains discernible behind the indicator 70. Additionally, the indicator 70 may be semi-transparent or an outline of the object/item 64, such that the object/item 64 remains discernible behind or enclosed by the indicator 70. In other embodiments, the indicator 70 may be large enough to completely cover the object/item 64 portrayed on the display 24. Indeed, in some embodiments, the indicator 70 may cover a majority or the entirety of the mobile communication device display 24.

The user 62 may opt to execute the object recognition application 14 and AR presentation application 17 at any desired moment and begin video capture and analysis. However, in some embodiments, the object recognition application 14 and AR presentation application 17 includes an “always on” feature in which the mobile communication device 10 is continuously capturing video and analyzing the objects/items 64 within the video stream. In such embodiments, the object recognition application 14 may be configured to alert the user 62 that a particular object/item 64 has been identified. The user 62 may set any number of user preferences to tailor the object recognition and AR presentation experience to their needs. For instance, the user 62 may opt to only be alerted if a certain particular object/item 64 is identified. Additionally, it will be appreciated that the “always on” feature in which video is continuously captured may consume the mobile communication device power source 32 more quickly. Thus, in some embodiments, the “always on” feature may disengage if a determined event occurs such as low power source 32, low levels of light for an extended period of time (e.g., such as if the mobile communication device 10 is in a user's pocket obstructing a clear view of the environment 68 from the mobile communication device 10), if the mobile communication device 10 remains stationary (thus receiving the same video stream) for an extended period of time, the user sets a certain time of day to disengage, or the like. Conversely, if the “always on” feature is disengaged due to the occurrence of such an event, the user 62 may opt for the “always on” feature to re-engage after the duration of the disengaging event (e.g., power source 32 is re-charged, light levels are increased, or the like.).

In some embodiments, the user 62 may identify objects 64 that the object recognition application 14 does not identify and add it to the data storage 48 with desired information in order to be identified and/or displayed in the future. For instance, the user 62 may select an unidentified object 64 and enter a name/title and/or any other desired information for the unidentified object 64. In such embodiments, the object recognition application 14 may detect/record certain markers 66 about the object so that the pattern recognition algorithm(s) (or other identification means) may detect the object 64 in the future. Furthermore, in cases where the object information is within the data storage 48, but the object recognition application 14 fails to identify the object 64 (e.g., one or more identifying characteristics or markers 66 of the object has changed since it was added to the data storage 48 or the marker 66 simply was not identified), the user 62 may select the object 64 and associate it with an object 64 already stored in the data storage 48. In such cases, the object recognition application 14 may be capable of updating the markers 66 for the object 64 in order to identify the object in future video streams.

In addition, in some embodiments, the user 62 may opt to edit the information or add to the information provided by the indicator 70. For instance, the user 62 may opt to include user-specific information about a certain object 64 such that the information may be displayed upon a future identification of the object 64. Conversely, in some embodiments, the user may opt to delete or hide an object 64 from being identified and an indicator 70 associated therewith being displayed on the mobile communication device display 24.

Furthermore, in some instances, an object 64 may include one or more markers 66 identified by the object recognition application 14 that leads the object recognition application 14 to associate an object with more than one objects in the data storage 48. In such instances, the user 62 may be presented with multiple candidate identifications and may opt to choose the appropriate identification or input a different identification. The multiple candidates may be presented to the user 62 by any means. For instance, in one embodiment, the candidates are presented to the user 62 as a list wherein the “strongest” candidate is listed first based on reliability of the identification. Upon input by the user 62 identifying the object 64, the object recognition application 14 may “learn” from the input and store additional markers 66 in order to avoid multiple identification candidates for the same object 64 in future identifications.

Additionally, the object recognition application 14 may utilize other metrics for identification than identification algorithms. For instance, the object recognition application 14 may utilize the user's location, time of day, season, weather, speed of location changes (e.g., walking versus traveling), “busyness” (e.g., how many objects are in motion versus stationary in the video stream), as well any number of other conceivable factors in determining the identification of objects 64. Moreover, the user 62 may input preferences or other metrics for which the object recognition application 14 may utilize to narrow results of identified objects 64.

In some embodiments, the AR presentation application 17 may have the ability to gather and report user interactions with displayed indicators 70. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects that is retrieved for presentation to a user via the mobile communication device may be permanently or semi-permanently associated with the object. In other words, the object may be “tagged” with the information. In some embodiments, a location pointer is associated with an object after information is retrieved regarding the object. In this regard, subsequent mobile communication devices capturing the object for recognition may retrieve the associated information, tags and/or pointers in order to more quickly retrieve information regarding the object. In some embodiments, the mobile communication device provides the user an opportunity to post messages, links to information or the like and associate such postings with the object. Subsequent users may then be presenting such postings when their mobile communication devices capture and recognize an object. In some embodiments, the information gathered through the recognition and information retrieval process may be posted by the user in association with the object. Such tags and/or postings may be stored in a predetermined memory and/or database for ease of searching and retrieval.

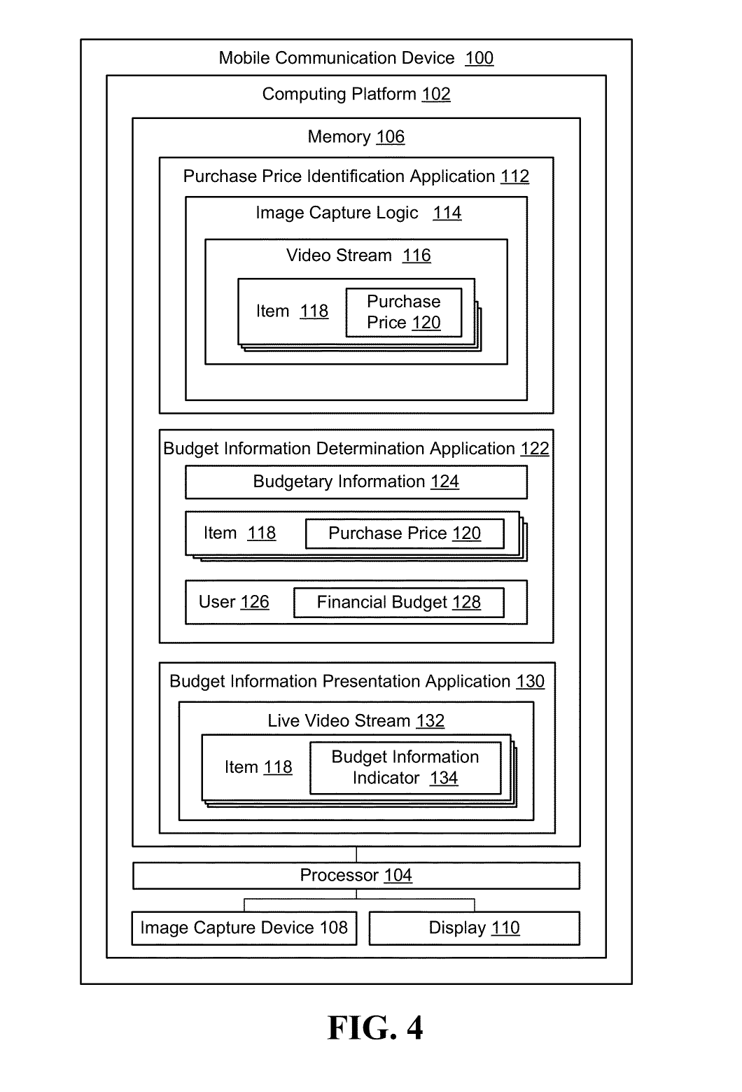

Referring to FIG. 4, a mobile communication device 100 configured for presenting budget information in connection with items within a live video stream is presented, in accordance with embodiments of the present invention. The mobile communication device 100 may comprise any device suitable for mobility that includes a display and an image capturing device (i.e., video camera or the like), for example, a smart telephone, a wearable computer having an Optical Head-Mounted Display (OHMD) or the like. It should be noted that while many embodiments of the mobile communication device are personal and/or handheld devices, in other embodiments of the invention a mobile communication device may be permanently or temporarily located within a moving vehicle, such as an automobile or the like. The mobile communication device includes a computing platform 102 having a processor 104 and a memory 106 in communication with the processor. Additionally, mobile communication device 100 includes image capture device 108 and display 110 both in communication with processor 104.

It should be noted that the applications shown and described in mobile communication device 100 may reside and be executed on the mobile communication device 100 or a network device that is in wireless communication with the mobile communication device 100.

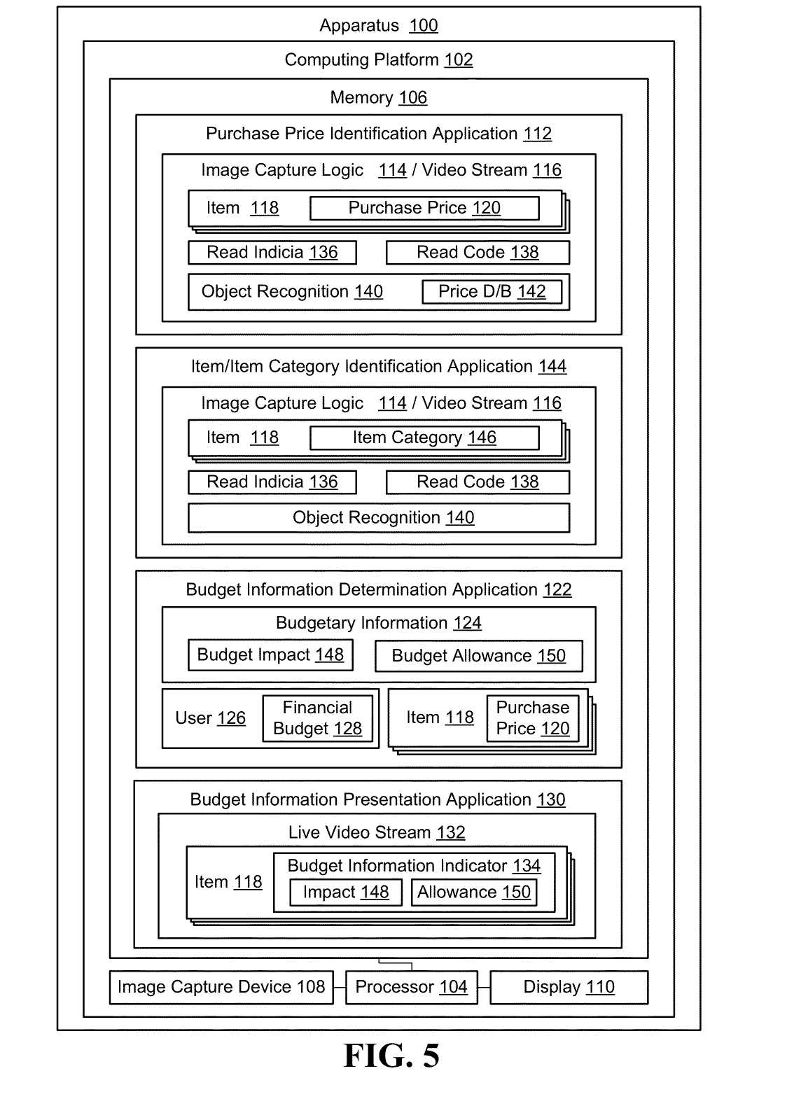

The memory 106 of mobile communication device 100 includes purchase price identification application 112 that is configured to determine the purchase price of items captured in video stream 116 by the image capture device 108 (i.e., items that are displayed in the display 110 of the mobile communication device 100). As such, purchase price identification application 112 includes image capture logic 114 that is in communication with image capture device 108 and configured to capture a video stream 116 of a surrounding environment that includes one or more items 118 that are subject to purchase. It should be noted that the video stream 114 may be captured from various different surrounding environments. For example, the video stream 114 may be captured while shopping in a retail location, such as an aisle of a grocery store, department store, home improvement store, restaurant (e.g., the menu) or the like. In addition, the video stream 114 may be captured in the user residence, such as video of the contents of a pantry, cupboard, storage area, a refrigerator or the like. In other embodiments, the video stream 114 may be captured while watching media, such as television, Internet or the like, reading media, such as via the Internet, a billboard advertisement, magazine, newspaper or the like. The purchase price identification application is further configured to determine that one or more images in the live video stream 116 identify the purchase price 120 of one or more items 118. As discussed in relation to FIG. 5 infra., purchase price 120 may be identified by capturing and reading indicia on an item (e.g., the purchase price or the like), capturing and reading an image-based code (e.g., barcode, Quick Response (QR) code or the like) or though implementation of object recognition techniques. It should be noted that for purposes of specific embodiments of the invention determination of the purchase price 120 does not require identification of the item 118 to which the purchase price 120 corresponds. However, in other embodiments of the invention (discussed in relation to FIG. 5) it may be necessary to identify the item 118, as well as the purchase price for the purposes of further comparison to the financial budget 128.

The memory 106 of mobile communication device 100 additionally includes budget information determination application 120 configured to determine budgetary information 124 by comparing the purchase price 120 of the items 118 to a financial budget 128 associated with the user 126 of the mobile communication device. The financial budget 128 may be stored on the mobile communication device 100 or, in the event that the financial budget does not reside locally but rather is stored on a network server (not shown in FIG. 4) the comparison may require network access (e.g., wireless or cellular) to the network server.

The memory 106 of mobile communication device 100 additionally includes budget information presentation application 130 (which may take the form of AR presentation application 17 shown and described in relation to FIG. 1) that is configured to present, within the live video stream 132 displayed on the display 110 of the mobile communication device 100, one or more budget information indicators 134. Each budget information indicator 134 is associated with determined budgetary information 124 and is “attached” to a corresponding item 118. “Attached” to an item 118 is defined herein as following (i.e., moving with) the corresponding item as the item moves within the live video stream 132 or moved in and out of the live video stream 132 that is displayed on the display 11 of the mobile communication device 100. Such “attachment” of the budget information indicator 134 to the corresponding item 118 creates an augmented reality environment within the display 110 of the mobile communication device 100.

In specific embodiments of the invention the budget information indicator 134 may be a graphical tag, highlighted area or an outline around the border of the item 118 as displayed in the live video stream 132. In specific embodiments, the budget information indicator 134 may be activatable (e.g., embedded hyperlinks or the like). In such embodiments of the invention, the user 126 of the mobile communication device 100 may activate the budget information indicator 134, through touch, mouse-pointer click, keypad, voice command or the like, to display further information regarding the purchase price 120, the financial budget 128, the financial budget 128 in comparison to the purchase price 120 or the item 118.

In specific embodiments of the invention, the user 126 of the mobile communication device 100 may be actively “looking” for budgetary information related to items by positioning the image capture device 108 in front of items 118 so as to capture the video stream 116, subsequently identify the purchase price 120 of the items, determine budgetary information 124 and present the budget information indicators 134 in the live video stream 132 that the user 126 is viewing through the display 110. For example, the user positions the mobile communication device to scan the aisle of a grocery store or their pantry within their residence. In other embodiments of the invention, the user may not be actively “looking” for budgetary information 124, but the image capture device 108 may be automatically “looking” for budgetary information 124 for predetermined items 118 or category of items, as configured by the user 126, through the use of a software agent and/or algorithm.

In other specific embodiments of the invention, the user may be passively “looking” for offers, such as when the mobile communication device 100 has been configured to search for specific items or categories of items and, when found, present related budget information or the like. In such a passive mode, the mobile communication device may be in a continuously-on mode and/or automatically turned on and off on a predetermined periodical schedule (i.e., intermittent mode). In the passive mode, determination and presentation of budget information may require that the user be prompted to notify the user of the item and corresponding budget information pertaining to the item. The prompt may include communicating an alert to the user, such as an audio alert communicated from the mobile communication device, e.g., an audible alarm or the like, and/or a visual alert, e.g., display of a flashing light on the mobile communication device or the like.

FIG. 5 is an additional block diagram of an mobile communication device 100 configured for presenting budget information in connection with items within a live video stream is presented, in accordance with embodiments of the present invention, in accordance with embodiments of the present invention. In addition to highlighting and describing further details of the invention, FIG. 5 provides for alternate embodiments of the invention. The mobile communication device 100 includes a computing platform 102 having at least one processor 104 and a memory 106 in communication with the processor. Memory 106 may be resident on mobile communication device or at least a portion of memory 106 may be remote memory that is network accessible to a mobile communication device, for example, at least a portion of memory 106 may reside on servers or the like as part of financial service/financial budgeting network. Memory 106 may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Processor 104 may be an application-specific integrated circuit (“ASIC”), or other integrated circuit set, processor, logic circuit, or other data processing device. Processor 104 or other processor such as an Application Specific Integrated Circuit (ASIC) may execute an application programming interface (“API”) layer (not shown in FIG. 5) that interfaces with any resident programs or applications, such as purchase price identification application 112, item/item category identification application 144, budget information determination application 122, and budget information presentation application 130 stored in the memory 106 of the mobile communication device 100.

Processor 104 may include various processing subsystems (not shown in FIG. 5) embodied in hardware, firmware, software, and combinations thereof, that enable the functionality of mobile communication device 100 and the operability of the mobile communication device 100 on a network. For example, processing subsystems allow for initiating and maintaining communications, and exchanging data, with other networked devices. For the disclosed embodiments, processing subsystems of mobile communication device 100 may include any subsystem used in conjunction with applications, applications, components and routines described herein.

In some embodiments, the processor 104 may also be capable of operating one or more applications, such as one or more applications functioning as an artificial intelligence (“AI”) engine. The processor 104 may recognize objects that it has identified in prior uses by way of the AI engine. In this way, the processor 104 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other applications or applications described herein to perform the various steps of the methods discussed. For example, in some embodiments, the AI engine recognizes an object that has been recognized before and stored by the AI engine. The AI engine may then communicate to another application or application of the mobile communication device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

As previously discussed, the memory 106 of mobile communication device 100 includes purchase price identification application 112 that is configured to determine the purchase price of items captured in video stream 116 by the image capture device 108 (i.e., items that are displayed in the display 110 of the mobile communication device 100). As such, purchase price identification application 112 includes image capture logic 114 that is in communication with image capture device 108 and configured to capture a video stream 116 of a surrounding environment that includes one or more items 118 that are subject to purchase. The purchase price identification application is further configured to determine that one or more images in the live video stream 116 identify the purchase price 120 of one or more items 118.

The purchase price 120 may be identified by capturing and reading indicia 136 on an item (e.g., the purchase price or the like), capturing and reading an image-based code 138 (e.g., barcode, Quick Response (QR) code or the like) located on or proximate to the item. In other specific embodiments of the invention, object recognition processing 140 may be implemented to identify objects as items and, once identified, access a pricing database 142 that lists the items 118 and the corresponding purchase price 120. Object recognition processing, as discussed previously at length in relation to FIGS. 1 and 2 identifies items 118 in the video stream 116 based on pattern recognition that compares images of the items to stored markers associated with the items. The pricing database that is accessed may be generic pricing database that lists manufacturer's suggested retail pricing for known items/products or the pricing database may be specific to the surrounding environment (e.g., retail location pricing database or the like) and list the current purchase price for the corresponding items. In specific embodiments of the invention, object recognition processing 140 may be implemented as the back-up source for determining the purchase price 120 in the event that the image capture logic 114 is unable to properly read indicia 136 or code 138 or if the item of interest does not have associated indicia 136 or code 138.

In specific alternative embodiments of the invention, the memory 106 of mobile communication device 100 includes item/item category identification application 144 that is configured to determine that one or more images in the video stream 116 identify the items and/or the category or classification of the items. Identifying the items may be required in those embodiments of the invention in which the financial budget is capable of providing budgetary information 124 based not only on purchase price of an item, but also based on the identity of the item (e.g., name of product or the like) and the category/classification of the item (e.g., food product, household product, entertainment product and the like). As such, item/item category identification application 144 includes image capture logic 114 that is in communication with image capture device 108 and configured to capture a video stream 116 of a surrounding environment that includes one or more items 118 that are subject to purchase. The item/item category identification application is further configured to determine that one or more images in the live video stream 116 identify the one or more items 118 or the category/classification of the items 118. The identity of items 118 may be determined by capturing and reading indicia 136 on an item (e.g., the name of the item or the like), capturing and reading an image-based code 138 (e.g., barcode, Quick Response (QR) code or the like) located on or proximate to the item. In other specific embodiments of the invention, object recognition processing 140 may be implemented to identify items or the category of an item in the video stream 116.

In other embodiments of the invention, the item/item category identification application 144 may identify or assist in identifying the one or more items 118 based on the geographic location of the items or information communicated from the items. In such embodiments, the product identification application 118 may be configured to identify items 116 by implementing geo-fencing techniques or any other spatial technique. In other such embodiments, the item identification application 144 may be configured to sense and receive short range communication, such as via Near Field Communication (NFC), Radio Frequency Identification (RFID), Bluetooth® or the like, which includes identification of the items. Since product identification based on location and/or information communicated from the items does not rely on an image for identification, such identification may be lieu of or implemented in combination with visual identification techniques described above.

The memory 106 of mobile communication device 100 additionally includes budget information determination application 120 configured to determine budgetary information 124 by comparing the purchase price 120 of the items 118 to a financial budget 128 associated with the user 126 of the mobile communication device. The financial budget 128 may be stored on the mobile communication device 100 or, in the event that the financial budget does not reside locally but rather is stored on a network server (not shown in FIG. 5) the comparison may require network access (e.g., wireless or cellular) to the network server. The budgetary information 124 that is determined may include, but is not limited to, the impact on the budget 148 (overall budget impact and/or category budget impact) that would result if the user were to purchase an item. Budget impact may be defined by the balance (amount or percentage) that would remain in the budget if the item were purchased. In other embodiments of the invention, budgetary information 124 may include whether the purchase price of an item is within budget allowance 150 based on current budget thresholds/limits (overall budget and/or budget categories) and previous expenditures undertaken by the user during the budget period (e.g., current week, current month, previous predetermined period of time or the like).

The memory 106 of mobile communication device 100 additionally includes budget information presentation application 130 (which may take the form of AR presentation application 17 shown and described in relation to FIG. 1) that is configured to present, within the live video stream 132 displayed on the display 110 of the mobile communication device 100, one or more budget information indicators 134. Each budget information indicator 134 is associated with determined budgetary information 124 and is “attached” to a corresponding item 118 such that as the item moves within the live video stream 132 or moves in and out of the live video stream 132 the budget information indicator 134 that is displayed on the display 11 of the mobile communication device 100 moves with the item. Such “attachment” of the budget information indicator 134 to the corresponding item 118 creates an augmented reality environment within the display 110 of the mobile communication device 100.

In specific embodiments of the invention, the budget information indicator 134 may indicate the impact 148 on the budget (or budget category) based on the user purchasing the corresponding item 118. For example, the indicator 134 may present or provide access to an amount or percentage that would remain in the budget if the item was purchased (or if the purchase of the item would exceed the budget the budget deficit amount or percentage that would result from purchasing the item). In other embodiments of the invention, the budget information indicator 134 may be limited to being attached to those items that are within budgetary allowance (i.e., purchase of the item would not exceed current budget limits/thresholds for the predetermined budgetary period). In such embodiments, the indicator 134 may comprise highlighting, outlining or otherwise visually indicating those items that are within budget allowance (overall budget allowance and/or category budget allowance).

As previous noted, in specific embodiments of the invention the budget information indicator 134 may be a graphical tag, highlighted area or an outline around the border of the item 118 as displayed in the live video stream 132. In specific embodiments, the budget information indicator 134 may be activatable (e.g., embedded hyperlinks or the like). In such embodiments of the invention, the user 126 of the mobile communication device 100 may activate the budget information indicator 134, through touch, mouse-pointer click, keypad, voice command or the like, to display further information regarding the purchase price 120, the financial budget 128, the financial budget 128 in comparison to the purchase price 120 or the item 118.

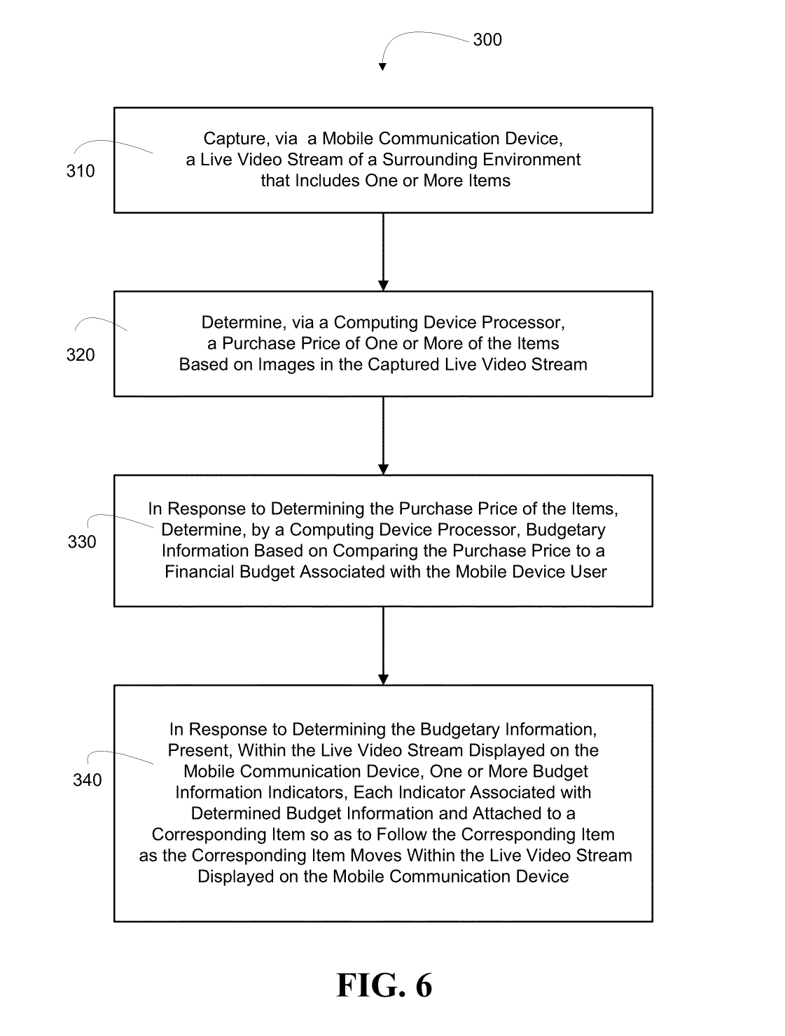

Referring to FIG. 6 a flow diagram is depicted of a method 300 for presenting budget information in connection with items within a live video stream is presented, in accordance with embodiments of the present invention, in accordance with embodiments of the present invention. At Event 310, a video stream is captured by a mobile communication device, such as smart telephone, a wearable computer including an OHMD or the like. The video stream is of a surrounding environment that includes one or items that are purchasable. For example, the surrounding environment may be a retail location, a grocery store, or the like. While in other embodiments the surrounding environment may be a menu or another list of purchasable items.

At Event 320, the purchase price of the items in the video stream are determined based on the captured images in the video stream. In specific embodiments of the invention, indicia may be read from the items (or from tags proximate to the items) that identify the purchase price of the items, while in other embodiments image-based codes, such as barcodes, QR codes or the like may be read that identify the purchase price of the items. In addition, such indicia and/or codes may be read to identify the items and/or the category in which the items are associated with for budgeting purposes. In other specific embodiments of the invention, object recognition processing may be implemented to identify objects in the video stream that are purchasable items. Such object recognition processing provides for patterns in the image of the object to be compared to stored markers as a means of positively identifying the object/item. Once the item is identified, a purchase price may be identified by accessing a pricing database that lists items and corresponding purchase prices.

At Event 330, in response to determining the purchase price of the items, budgetary information is determined based on comparing the purchase prices to a financial budget associated with the user of the mobile communication device. In this regard, the financial budget of the user, which may be stored on the mobile communication device, in a network cloud and/or at a network server, is accessed and the purchase price of the items is compared to the financial budget of the user and/or specific categories within the financial budget to which the items being considered for purchase reside. The financial budget of the user may provide for specific amounts (or percentage of income) allocated to specific spend categories for a specified period of time (e.g., weekly, monthly or the like. In addition, the financial budget may provide for tracking expenditures (both in an automated fashion and/or through manual user entry) undertaken by the user to assess the performance of the user in meeting financial budget goals/limits or the like. Thus, in the present invention, the budgetary information that is determined may include determining the impact on the user's financial budget and/or a category within the financial budget. In this regard, the present invention may determine the monetary effect on the financial budget and/or one or more categories within the budget based on the user purchasing the item (i.e., how much would remain in the budget after purchase or how the budget would be exceeded by). In other embodiments of the invention, the impact on the user's financial budget may be defined by the percentage that the purchase price would impact the financial budget or a category of the financial budget. (e.g., the purchase price is $25 of an article of clothing is and the category of clothing has a budget limit of $500/annually−the percentage impact on the purchase would be 5.0%).

In other embodiments of the invention, the budgetary information includes a determination as to whether a purchase of the item is within the financial budget allowances/limits for the overall budget or a category within the budget. Such a determination takes into account the user's ability, automated or otherwise, to track expenditures and to categorize the expenditures in terms of budget categories. For example, if $150 remains in a user's annual budget for clothing expenditures and the purchase price of a clothing item being considered (i.e., viewable within the live video stream on the mobile communication device) is $200, the purchase price would be considered to be outside of the budget allowance/limit associated with the clothing category, if however, the clothing item being considered is $50 it would be determined to be within current budget allowance/limits.

At Event 340, in response to determining the budgetary information, one or more indicators are presented on the display of the mobile communication device in conjunction with live video stream. Each of the indicators is associated with budgetary information and are “attached” to a corresponding item so as to follow the corresponding item in the display as the corresponding item moves within the live video stream displayed on the mobile communication device. The corresponding item may physically move or may be stationary but move within the display due to movement of the mobile communication device. Such attachment of the indicator to the item creates an augmented reality environment within the display. The indicator may be presented proximate to a location of a corresponding item. As previously noted, the indicator may take various forms, such as display of a tag, a highlighted area, a hot-spot or the like. In specific embodiments, the indicator is a selectable indicator, such that a user may select (e.g., click-on, hover-over, touch the display, provide a voice command or the like) the indicator to provide display of specifics related to the budgetary. In other embodiments, the indicator itself may provide the budgetary information or a portion of the budgetary information. For example, the indicator may highlight, outline or superimpose items that are within budgetary allowance/threshold so that the user can readily see which items within view are within budget allowance. In other embodiments, the indicator may indicate the budget impact by depicting the amount that would remain in a budget allocation if the item was purchased or the percentage of the budget that would be associated with the purchase of the item.

Thus, methods, systems, computer programs and the like have been disclosed that provide for presenting budget information in connection with items within a live video stream of an augmented reality display on a mobile communication device. The invention allows the user who customarily comes in to contact with items throughout the day to able to gauge the budget impact of the purchase of such items and/or immediately ascertain whether certain items being considered for purchase are within the limits of a user's budget or a budget category. By automatically providing such information to the user in a highly efficient manner, the user can make informed decisions on whether a purchase is advisable and/or which purchase options are most suitable to the user's budget.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for presenting budget-information in conjunction with a live video stream display of one or more items on a mobile communication device, the apparatus comprising:
a mobile communication device including a computing platform including a processor, a memory in communication with the processor and an image capturing device in communication with the processor;
purchase price identification application stored in the memory, executable by the processor and the image capturing device and configured to capture a live video stream of a surrounding environment that includes one or more items and determine that one or more images in the live video stream identify a purchase price of the one or more items;
budget information determination application stored in the memory, executable by the processor and configured to determine budgetary information based on comparing the purchase price of the items to a financial budget associated with a user of the mobile communication device; and
a budget information presentation application stored in the memory, executable by the processor and configured to, in response to determining the budgetary information, present, within the live video stream displayed on the mobile communication device, one or more budget information indicators, each budget information indicator associated with the determined budget information and attached to a corresponding item so as to follow the corresponding item as the corresponding item moves within the live video stream displayed on the mobile communication device.

2. The apparatus of claim 1, further comprising an item identification application stored in the memory, executable by the processor and the image capturing device and configured to capture a live video stream of a surrounding environment that includes one or more items and determine that one or more images in the live video stream identify the one or more items or a category for the one or more items.

3. The apparatus of claim 2, wherein the item identification application is further configured to implement object recognition processing that provides for identifying the items in the live video stream based on pattern recognition that compares images of the items to stored markers associated with the items, and wherein the purchase price identification application is further configured to identify the purchase price of identified items by accessing a pricing database that stores purchase prices for items.

4. The apparatus of claim 1, wherein the budget information determination application is further configured to compare the purchase price of an item to the financial budget associated with the user to determine an impact on the financial budget based on the user purchasing the item.

5. The apparatus of claim 4, wherein the budget information presentation application is further configured to, in response to determining the impact on the financial budget, present, within the live video stream displayed on the mobile communication device, the one or more budget information indicators, wherein the budget information indicators indicate the impact on the financial budget of the user purchasing the item.

6. The apparatus of claim 1, wherein the budget information presentation application is further configured to, in response to determining the budgetary information, present, within the live video stream displayed on the mobile communication device, the one or more budget information indicators, wherein the budget information indicators correspond to items that are within budgetary limits of the user.

7. The apparatus of claim 2, wherein the budget information determination application stored in the memory, executable by the processor and configured to determine a budget category for each of the identified items, compare the purchase price to the determined budget category within the financial budget to determine an impact on the budget category based on the user purchasing the item and wherein the budget information presentation application is further configured to, in response to determining the impact on the budget category, present, within the live video stream displayed on the mobile communication device, the one or more budget information indicators, wherein the budget information indicators indicate the impact on the budget category of the user purchasing the item.

8. The apparatus of claim 1, wherein the budget information presentation application is further configured to, in response to determining the budgetary information, present, within the live video stream displayed on the mobile communication device, one or more budget information indicators, wherein the budget information indicator is a graphical representation that highlights, superimposes or outlines the corresponding item.

9. The apparatus of claim 1, wherein the purchase price identification application is further configured to identify the purchase price of the one or more items by reading indicia or an image-based code captured by the mobile communication device, wherein the indicia or image-based code further identifies the one or more items.

10. A method for presenting budget-information in conjunction with a live video stream display of one or more items on a mobile communication device, the method comprising:
capturing, by a mobile communication device, a live video stream of a surrounding environment that includes one or more items;
determining, by a computing processor device, a purchase price of one or more of the items based on one or more images in the captured live video stream;
in response to determining the purchase price of the items, determining, by a computing processor device, budgetary information based on comparing the purchase price of the items to a financial budget associated with a user of the mobile communication device; and
in response to determining the budgetary information, presenting, by a computing processor device, within the live video stream displayed on the mobile communication device, one or more budget information indicators, each budget information indicator associated with the determined budget information and attached to a corresponding item so as to follow the corresponding item as the corresponding item moves within the live video stream displayed on the mobile communication device.

11. The method of claim 10, further comprising determining, by a computing processor device, that one or more images in the live video stream identify, at least one of (1) the one or more items or (2) a category for the one or more items.

12. The method of claim 11, wherein determining that one or more images in the live video stream identify the items further comprises implementing, by a computing processor device, object recognition processing that provides for identifying the items in the live video stream based on pattern recognition that compares images of the items to stored markers associated with the items, and wherein determining the purchase price of the one or more items further comprises determining the purchase price of identified items by accessing a pricing database that provides purchase prices for items.

13. The method of claim 10, wherein determining budgetary information further comprises comparing, by a computing processor device, the purchase price of an item to the financial budget associated with the user to determine an impact on the financial budget based on the user purchasing the item and wherein presenting one or more budget indicators further comprises presenting, by the computing processor device, within the live video stream displayed on the mobile communication device, the one or more budget information indicators, wherein the budget information indicators indicate the impact on the financial budget of the user purchasing the item.

14. The method of claim 10, wherein determining budgetary information further comprises comparing, by a computing processor device, the purchase price of an item to the financial budget associated with the user to determine that the item is within budgetary limits of the financial budget of the user and wherein presenting one or more budget indicators further comprises presenting, by the computing processor device, within the live video stream displayed on the mobile communication device, the one or more budget information indicators, wherein the budget information indicators correspond to items that are within budgetary limits of the user.

15. The method of claim 11, further comprising:
determining, by a computing processor device, a budget category for each of the identified items; and
comparing, by a computing device processor, the purchase price of one of the items to the determined budget category within the financial budget to determine an impact on the budget category based on the user purchasing the item,
wherein presenting the budget information indicators further comprises, in response to determining the impact on the budget category, presenting, within the live video stream displayed on the mobile communication device, the one or more budget information indicators, wherein the budget information indicators indicate the impact on the budget category of the user purchasing the item.

16. The method of claim 1, wherein determining the purchase price further comprises reading, by a computing device processor, indicia or an image-based code captured by the mobile communication device in the live video stream, wherein the indicia or image-based code further identifies the one or more items.

17. A computer program product comprising:
a non-transitory computer-readable medium comprising:
a first set of codes for causing a computer to capture a live video stream of a surrounding environment that includes one or more items;
a second set of codes for causing a computer to determine a purchase price of one or more of the items based on one or more images in the captured live video stream;
a third set of codes for causing a computer to, in response to determining the purchase price of the items, determine budgetary information based on comparing the purchase price of the items to a financial budget associated with a user of the mobile communication device; and
a fourth set of codes for causing a computer to, in response to determining the budgetary information, present, within the live video stream displayed on the mobile communication device, one or more budget information indicators, each budget information indicator associated with the determined budget information and attached to a corresponding item so as to follow the corresponding item as the corresponding item moves within the live video stream displayed on the mobile communication device.

18. The computer program product of claim 17, further comprising a fifth set of codes for causing a computer to determine that one or more images in the live video stream identify, at least one of (1) the one or more items or (2) a category for the one or more items by implementing object recognition processing that provides for identifying the items in the live video stream based on pattern recognition that compares images of the items to stored markers associated with the items, and wherein the second set of codes is further configured to cause the computer to determine the purchase price of identified items by accessing a pricing database that provides purchase prices for items.

19. The computer-program product of claim 17, wherein the third set of codes is further configured to cause the computer to compare the purchase price of an item to the financial budget associated with the user to determine an impact on the financial budget based on the user purchasing the item and the fourth set of codes is further configured to cause the computer to present, within the live video stream displayed on the mobile communication device, the one or more budget information indicators, wherein the budget information indicators indicate the impact on the financial budget of the user purchasing the item.

20. The computer program product of claim 17, wherein the third set of codes is further configured to cause the computer to compare the purchase price of an item to the financial budget associated with the user to determine that the item is within budgetary limits of the financial budget of the user, and wherein the fourth set of codes is further configured to cause the computer to present, within the live video stream displayed on the mobile communication device, the one or more budget information indicators, wherein the budget information indicators correspond to items that are within budgetary limits of the user.
